(19) United States
(12) Patent Application Publication
(10) Pub. No.: US 2013/0339118 A1
(43) Pub. Date: Dec. 19, 2013

(54) BULK PURCHASING BY AD HOC CONSUMER GROUPS

(71) Applicant: James Buscemi, Camarillo, CA (US)

(72) Inventor: James Buscemi, Camarillo, CA (US)

(73) Assignee: GBL SYSTEMS CORPORATION, Camarillo, CA (US)

(21) Appl. No.: 13/523,008

(22) Filed: Jun. 14, 2012

(51) Int. Cl. G06Q 30/02

(52) U.S. Cl. 705/14.24

(57) ABSTRACT

A central server allows a leader member to create a desired purchasing deal for a desired product or service. The leader member uses social networking applications at the central server and other means to market the desired purchasing deal to like minded consumers who join a purchasing group at the central server that follows the desired purchasing deal. The leader member also uses the central server and other means to market the desired purchasing deal to potential retailers, who register interest in the desired purchasing deal at the central server. As the size of the purchasing group increases, the leader member negotiates deeper and deeper discounts with the interested retailers until the purchasing group and a selected retailer are both satisfied with the deal. The system then facilitates the closing of the deal, which results in the consumers receiving the product or service and the retailer getting paid.

### BACKGROUND

1. Field of the Invention

The present invention is generally related to conventional and electronic commercial systems and is more specifically related to bulk purchasing by ad hoc consumer groups established using a social networking infrastructure and/or metagroups.

2. Related Art

Social commerce is a subset of electronic commerce that employs collaborative social media tools to assist in online purchasing and selling. Social commerce typically refers to recommendation and review sites such as Yahoo! Shopping but more recently has been expanded to refer to include a variety of collaborative commerce activities such as socialshopping.com where members not only share recommendations but also electronic coupon codes.

Academic research on social commerce has focused on the social networking aspects in online marketplaces and the value implications of this marketing tool for companies running social commerce marketplaces and for individuals participating in these marketplaces. This research defines social commerce as networks of sellers/shops in online marketplaces, whereas social shopping involves networks of buyers/customers in online marketplaces and online communities.

Social shopping is a method of e-commerce and traditional shopping in which consumers shop in a social networking environment such as Facebook or MySpace. In conventional social shopping, users communicate and aggregate information about products and prices, and share finds and deals from physical or online retailers through a website that facilitates interaction between users that have similar shopping interests. Some social shopping websites use established online social networks and tools such as Facebook Connect or Twitter that allows users to ask their Facebook friends or Twitter followers for opinions on purchases via the social shopping site.

These conventional social commerce systems all suffer from the failure to provide better deals to consumers than the deals that are already available. Therefore, what is needed is a system and method that overcomes these significant problems found in the conventional systems as described above.

### SUMMARY

Described herein is a system for leveraging the collective buying power of individual consumers by bringing like minded consumers together to form a bulk purchasing group and leveraging the size of the group in exchange for discounts on products and services from retailers. The system employs a central server that allows a leader member to create a desired purchasing deal for a desired product or service. The leader member uses social networking applications provided by the central server as well as external social networking applications and other means to market the desired purchasing deal to like minded consumers who join a purchasing group that follows the desired purchasing deal via the central server.

The leader member also uses social networking applications provided by the central server as well as external social networking applications and other means to market the desired purchasing deal to potential retailers, who register interest in the desired purchasing deal at the central server. As the size of the purchasing group increases, the leader member negotiates deeper and deeper discounts with the interested retailers until the purchasing group and a selected retailer are both satisfied with the deal. The system then facilitates the closing of the deal, which results in the consumers receiving the product or service and the retailer getting paid. Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating an example system for bulk purchasing by ad hoc consumer groups according to an embodiment of the present invention;

FIG. 2 is a block diagram illustrating an example bulk purchasing server according to an embodiment of the present invention;

FIG. 3 is a block diagram illustrating an example member module in a bulk purchasing server according to an embodiment of the present invention;

FIG. 4 is a block diagram illustrating an example groups module in a bulk purchasing server according to an embodiment of the present invention;

FIG. 5 is a block diagram illustrating an example deal module in a bulk purchasing server according to an embodiment of the present invention;

FIG. 6 is a block diagram illustrating an example rating module in a bulk purchasing server according to an embodiment of the present invention;

FIG. 7 is a flow diagram illustrating an example process for bulk purchasing by ad hoc consumer groups according to an embodiment of the present invention;

FIG. 8 is a block diagram illustrating an example wireless communication device that may be used in connection with various embodiments described herein; and

FIG. 9 is a block diagram illustrating an example computer system that may be used in connection with various embodiments described herein.

### DETAILED DESCRIPTION

Embodiments disclosed herein provide for leveraging the collective buying power of individual consumers by bringing like minded consumers together to form a bulk purchasing group and leveraging the size of the group in exchange for discounts on desired products and services from retailers. For example, one method as disclosed herein allows for a leader member to create a deal and market it to potential consumers and potential retailers. As the number of potential consumers included in the deal increases, the interest of potential retailers increases and the size of the discount similarly increases.

After reading this description it will become apparent to one skilled in the art how to implement the invention in various alternative embodiments and alternative applications. However, although various embodiments of the present invention will be described herein, it is understood that these embodiments are presented by way of example only, and not limitation. For simplicity of explanation, the following description will focus on a primary embodiment where the system is referred to as a Wolf Pack (“WP”) system and the ad hoc groups of consumers are referred to as Wolf Packs (“WPs”) or packs. However, this detailed description of the primary and alternative embodiments should not be construed to limit the scope or breadth of the present invention as set forth in the appended claims.

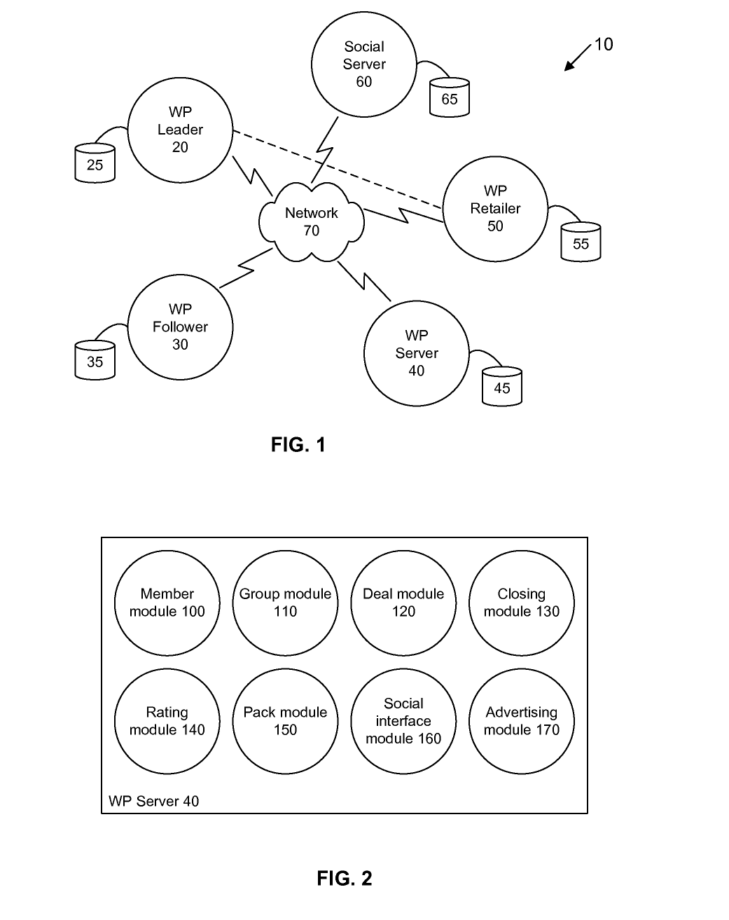

FIG. 1 is a network diagram illustrating an example system 10 for bulk purchasing by ad hoc consumer groups according to an embodiment of the present invention. In the illustrated embodiment, the system 10 comprises one or more WP leader devices 20 that are communicatively coupled with one or more WP follower devices 30, one or more WP server devices 40, one or more WP retailer devices 50 and one or more social server devices 60 via a communication network 70.

The one or more devices 20, 30, 40, 50, and 60 can be implemented using a processor controlled computing platform such as later describe with respect to FIGS. 10 and 11. The devices may be wired or wireless communication devices and are preferably capable of wired or wireless (or both) communication over the network 70 with the various other devices in the system 10. Each of the one or more devices is configured with an associated data storage area, namely data storage areas 25, 35, 45, 55, and 65. The data storage areas can comprise volatile and persistent data storage means and provide computer readable storage media that can store data along with instructions that are executable by one or more processors of the one or more devices. The network 70 may be a wired or wireless network, public or private, persistent or ad hoc and any combination of these. For example, the network may include a mobile ad hoc wireless network in combination with a terrestrial wired network that includes the well known Internet.

In operation of the system 10, the WP leader 20 accesses the WP server 40 via the network 70 and creates a potential deal for a desired product or service. The potential deal includes certain metrics such as an identification of the desired product or service and a target price for the desired product or service. The WP leader 20 provides all required information when creating the potential deal. A data structure for the potential deal is then stored in the data storage area 45. At this point, the WP server 40 may advertise the potential deal to any visitors to the web page interface of the WP server 40.

After creating the potential deal, the WP leader 20 identifies a plurality of potential WP followers 30 using the WP server 40 and communicates at least a portion of the various metrics of the potential deal to the potential WP followers 30. The WP leader 20 may communicate a potential deal to potential WP followers 30 via a direct communication over the network 70 such as an email message, text/SMS message, audio message (e.g., voicemail), multimedia message, or the like. The WP leader 20 may also communicate a potential deal to potential WP followers 30 via an indirect communication over the network 70 such as a post to one or more group message boards. Advantageously, the group message boards may be maintained by the WP server 40 or by one or more social servers 60 including, for example, Facebook, Twitter, MySpace, Google groups and Yahoo groups just to name a few.

The WP server 40 may also proactively promote the potential deal by notifying WP members of the potential deal via direct or indirect communications. Additionally, the WP server 40 analyzes the metrics of the potential deal and generates a deal score based on those metrics. In one embodiment, a wolf pack deal score and a separate retailer deal score can be generated based on the metrics of a potential deal. The deal score can be used as a relative rating for the potential deal and the WP server 40 can use the deal score to promote the highest rated potential deals. In one embodiment, the WP server 40 provides the deal score (or one or both of the wolf pack deal score and retailer deal score) when advertising the potential deal to any visitors (including potential WP followers 30 and potential WP retailers 50) to the web page interface of the WP server 40.

Additionally, one or more WP followers 30 may also proactively promote the potential deal using direct or indirect communications via the WP server 40 or one or more social servers 60. Such proactive promotion advantageously amplifies the exposure of the potential deal using viral marketing techniques.

Furthermore, the WP leader 20, one or more WP followers 30 and even the WP server 40 can proactively promote the potential deal to one or more potential WP retailers 50 using direct or indirect communications via the WP server 40. Additionally, the WP leader 20 may also employ offline communications not using the network 70 with one or more potential WP retailers 50 as illustrated by the dashed line. While WP followers 30 may also employ offline communications not using the network 70 with one or more potential WP retailers 50 (not shown), it is more common for the WP leader 20 to communicate and negotiate deal metrics with a potential WP retailer 50.

A potential WP retailer 50 can access the WP server 40 via the network 70 and review the various metrics of the potential deal to gauge the interest of the potential WP retailer 50. One or more potential WP retailers may send a direct or indirect (or offline) message to the WP leader 20 regarding the metrics of the deal to request modification of the metrics. For example, a potential WP retailer 50 may request that the minimum total aggregate number of the WP leader and WP followers for the deal be increased from 500 to 1000 in order for the WP retailer 50 to provide the desired 30% discount for the identified product. Advantageously, the WP leader 20 may modify the metrics of the deal based on the request of the WP retailer 50 and the modified data structure for the deal stored in the data storage area 45.

Alternatively, the WP leader 20 may use the modified metrics to create a competing deal for the wolf pack to consider such that a plurality of WP retailers 50 each have competing deals in place for the desired product or service with slightly different deal metrics. These competing deals each have a separate data structure stored in the data storage area 45 and each of these data structures are associated with the potential deal created by the WP leader 20. Advantageously, the various data structures for the competing deals can each be modified by the WP leader 20 as the size of the wolf pack grows and the collective purchasing power of the wolf pack correspondingly increases and the WP retailers 50 offer better discounts or alternative incentives to close the deal with the wolf pack.

In one embodiment, a WP follower 30 may request to become the WP leader 20. Advantageously, the WP server 40 may facilitate a change in status from WP leader 20 to WP follower 30 and vice versa. This may be particularly useful when a potential deal reaches a certain size and the potential deal begins generating interest directly from wholesale product providers or directly from the product manufacturer. As will be understood, in certain instances, a WP leader 20 with a different skill set may better represent the wolf pack in ongoing negotiations with potential WP retailers 50. Accordingly, the WP leader 20 may change multiple times during the lifespan of a potential deal to increase the collective purchasing power of the wolf pack.

At a point when the size of the wolf pack (i.e., the total number of WP followers 30 plus the WP leader 20) is sufficiently large such that the metrics of the deal meet the desires of the WP leader 20 and a selected WP retailer 50. The WP leader 20 accesses the WP server 40 and closes the deal. Closing the deal includes identifying the selected WP retailer 50 and each of the plurality of WP followers 30. In one embodiment, the WP retailer 50 is also required to affirm the closing of the deal and the associated metrics.

Upon closing of the deal, the WP server 40 may manage a funds transfer process that allows the WP retailer 50 to charge a credit card or other type of payment account (e.g., PayPal) for each WP follower 30 and the WP leader 20. Alternatively, the WP server 40 may charge the credit cards (or other such account) for the WP members (i.e., the WP leader 20 and WP followers 30) that are associated with the closed deal and then remit funds to the WP retailer 50. Alternative funds transfer transactions such as automated clearing house (“ACH”) or electronic funds transfer (“EFT”) may also be used. In one embodiment, the WP server 40 may provide a discount coupon or gift card to each WP member that is associated with the closed deal. Alternative ways to facilitate the transfer of goods or services in exchange for funds will be understood by those skilled in the art and are also contemplated as being used by the WP server 40.

Additionally, after a deal is closed, the WP server 40 coordinates updated ratings for the WP leader 20, the WP followers 30 and the WP retailer 50. Advantageously, each WP member profile has an associated separate rating for that member's participation in deals as a WP leader 20, WP follower 30, or WP retailer 50. Accordingly, the rating for the WP leader 20 is updated by the WP server 40 post closing to increase or decrease the rating based on the metrics of the closed deal. Similarly, the rating for each of the WP followers 30 is updated by the WP server 40 post closing to increase or decrease the rating based on, for example, whether or not the WP follower 30 promoted the potential deal and attracted additional WP followers 30 or whether or not the WP follower 30 used a provided coupon or gift card within a predetermined time period. Notably, the WP leader 20 may also have its follower rating updated after the close of the deal. Additionally, the rating for the WP retailer 50 is also updated post closing based on the metrics of the deal and perhaps also based on the quality of the goods or services provided and whether or not provided coupons or gift cards were accepted or denied at retail (brick and mortar or online) locations. A variety of parameters may be used to generate ratings for WP leaders, followers and retailers, as will be understood by those skilled in the art.

Finally, at the close of the deal the WP server 40 records in its data storage area the metrics of the deal and other demographic information related to the deal. The WP server 40 advantageously maintains a rich data set of closed deals and related demographic information and such data can be mined to identify trends and other such useful information that provide additional bargaining power to future wolf packs or that can be packaged and sold to market analysis firms or other interested groups.

FIG. 2 is a block diagram illustrating an example WP server 40 according to an embodiment of the present invention. The WP server 40 comprises programmed modules that are stored in data storage area 45 and executed by one or more processors to carry out their respective functions. In the illustrated embodiment, the WP server 40 comprises a member module 100, a group module 110, a deal module 120, a closing module 130, a rating module 140, a pack module 150, a social interface module 160 and an advertising module 170.

The member module 100 is configured to manage member profiles in the data storage area 45 of the WP server 40. The member module 100 also facilitates new members signing up with the WP server 40, for example, collecting demographic information about the member including name, address, city, state, zip, hobbies, interests, and other useful information that can be used to identify potential groups of like minded consumers that are also WP members.

The member module 100 also operates in conjunction with the rating module 140 to update the rating information in a member profile. In one embodiment, a member profile allows a WP member to operate as a WP leader, a WP follower or a WP retailer. Accordingly, business to business deals can be facilitated by the WP server 40 where the WP leader is a business entity and the WP followers are business entities and the wolf pack is purchasing goods from a business entity (e.g., a manufacturer or wholesaler).

The member module 100 also operates in conjunction with the groups module 110 to manage a particular member's association with one or more groups. Advantageously, the demographic information included in the member profile can be analyzed by the member module 100 to identify and propose potential groups for the member to approve association with.

The group module 110 is configured to manage groups of member profiles in the data storage area of the WP server 40. The group module 110 facilitates the creation of new groups as well as the splintering of new groups from existing groups. Advantageously a member can belong to multiple groups simultaneously so when splintering a new group from an existing group, the group module 110 can use a particular common demographic to create the splinter group and seed the splinter group with only those members of the existing group that share the common demographic. The groups module also maintains a hierarchy of related groups to facilitate identification of like minded consumers based on group memberships.

The deal module 120 is configured to create and manage deals on behalf of a wolf pack and store and modify the data structure for a deal in the data storage area 45 of the WP server 40. The deal module 120 also operates in conjunction with the group module 110 and the member module 100 to populate a deal with WP followers and operates in conjunction with the closing module 130 to close an accepted deal. The deal module 120 additionally operates in conjunction with the rating module 140 and the member module 100 to update WP leader, WP follower and WP retailer ratings in the various member profiles after the closing of a deal. The deal module also operates in conjunction with the social interface module to facilitate the sharing of information about a potential deal and to facilitate the marketing of a potential deal to potential WP followers and WP retailers.

The closing module 130 is configured to manage the transfer of funds from WP leader and WP followers to the WP retailer at the close of a deal and the corresponding transfer of coupons or gift cards from the WP retailer to the WP leader and WP followers. In one embodiment, the closing module 130 may facilitate a direct funds transfer transaction between the WP retailer and the WP leader and WP followers. Such a direct funds transfer may be carried out by a series of transactions, e.g., credit card, ACH, EFT, or PayPal, to name just a few. Alternatively, the closing module 130 may facilitate an indirect funds transfer transaction between the WP retailer and the WP leader and WP followers. Such an indirect funds transfer may also be carried out by a series of transactions (e.g., credit card, ACH, EFT, or PayPal, etc.) between the WP server 40 and the WP leader and WP followers followed by a single or a series of transactions between the WP server 40 and the WP retailer. The closing module 130 is also configured to track usage of coupons and gift cards by WP followers and the WP leader post closing and operates in conjunction with the rating module 140 to facilitate updating the rating of WP followers and the WP leader based on timely remittance of the coupon or gift card by the respective WP followers and WP leader.

The rating module 140 is configured to manage the ratings of individual members in their various capacities as WP leader, WP follower and WP retailer. The ratings module 140 operates in conjunction with the member module 100 and the deal module 120 to analyze the metrics of a deal post closing and update the corresponding WP leader rating, WP follower rating and WP retailer rating for the participants of the closed deal.

Additionally, the rating module 140 is configured to analyze the metrics of a potential deal and create a deal score that is a rating for the potential deal. Advantageously, the rating module 140 may analyze demographic data from completed deals that is stored in the data storage area 45 of the WP server 40 and compare the metrics and other demographic data from the past deals to the metrics and demographic data of the potential deal to generate the deal score and rating. In one embodiment, the WP leader and potential WP retailer(s) may be factored into the deal score and rating.

The pack module 150 is configured to manage previously constructed ad hoc wolf packs and maintain those wolf packs in the data storage area 45 of the WP server 40. Advantageously, the pack module 150 facilitates persistent wolf packs that are then capable of creating, marketing and closing a plurality of deals in a serial and/or parallel fashion. The pack module 150 also operates in conjunction with the member module 100, group module 110, and deal module 120 to update the WP members that are part of a persistent wolf pack. Advantageously, a persistent wolf pack may include a plurality of potential WP leaders, WP followers and WP retailers. In one embodiment, a persistent wolf pack is created for the purpose of regularly conducting a recurring transaction. For example, a persistent wolf pack may include a plurality of WP leaders and WP followers that regularly purchase perishable items such as flowers. The persistent wolf pack may also include several WP retailers that sell flowers. Once per month, the persistent wolf pack may leverage its collective purchasing power to purchase a significant number of flowers from one or more of the WP retailers. The persistent wolf pack may advantageously add additional WP leaders and WP followers and WP retailers over time, providing a regular and recurring potential source of business for the WP retailers while also providing the WP leaders and WP followers with superior prices on their respective purchases.

The social interface module 160 is configured to manage the use of social media applications on the WP server 40 by WP leaders and WP followers to generate interest in a potential deal and facilitate the addition of WP followers to a potential deal. The social interface module 160 is also configured to manage the use of external social media applications such as Facebook, MySpace, Twitter and the like for the same purpose. The social interface module 160 additionally operates in conjunction with the group module 110 to facilitate the identification of external groups that can be leveraged to assist a WP leader or WP follower in marketing a potential deal to like minded consumers. In this capacity, the social interface module 160 may obtain metadata information about external social networking applications and groups and provide that metadata to the group module 110 for use in expansion of the WP server 40 groups stored in the data storage area 45 using the identified external groups and corresponding metadata.

The social interface module 160 is also configured to generate sitemaps and site feeds that the WP server 40 stores in the data storage area 45 for delivery to a search engine. Advantageously, the sitemaps and site feeds not only reflect the pages hosted by the web server interface of the WP server 40, e.g., one page per potential deal, but they also provide external search engines with information regarding the demographics of the various potential deals that are in progress so they can be more easily found by non WP members through conventional searches and drive potential WP member traffic to the WP server 40 for conversion into a WP member and a WP follower for a potential deal.

In one embodiment, the relative deal scores and ratings for potential deals can be used to determine the relative priority value of the various pages. This relative priority value is then included in the sitemap as the value of the <priority> tag so that the higher rated deals are automatically given higher priority in a search result by a conventional search engine. Advantageously, sitemaps and feed data can be proactively delivered to search engines so that when new potential deals are created a new sitemap including the new potential deal can be generated and provided to a plurality of search engines. Similarly, the social interface module 160 is configured to provide updated information on potential deals to social networking outlets including Twitter and really simple syndication (“RSS”) feeds, just to name two.

The advertising module 170 is configured to facilitate standard and location based advertising from retailers that is directed toward potential purchasers who are WP members (e.g., WP leaders and WP followers). The advertising module 170 operates in conjunction with the member module 100 and group module 110 to identify WP members and groups of WP members with common interests. These common interest groups advantageously allow the WP server 40 to provide very specifically targeted audiences for WP retailers to advertise to. In one embodiment, the advertising from a WP retailer is not conventional advertising, but rather the WP advertising of a potential deal in search of a WP leader that is interested and motivated enough to take on the project of creating a wolf pack for the potential deal and marketing the potential deal and generating a sufficient number of WP followers to close the deal. In such an embodiment, the WP advertising comprises certain deal metrics such as the required number of WP followers and the corresponding discount. For example, there WP retailer may offer an increasing sliding scale discount based on increasing numbers of WP followers for the potential deal.

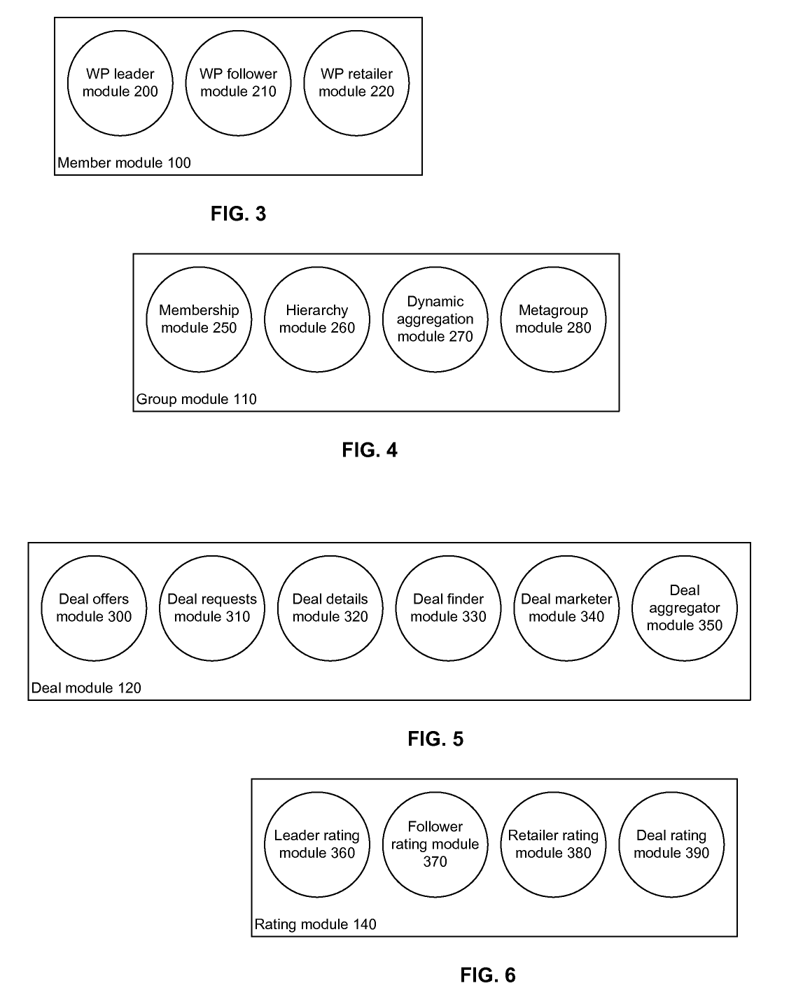

FIG. 3 is a block diagram illustrating an example member module 100 in a bulk purchasing server according to an embodiment of the present invention. In the illustrated embodiment, the member module 100 comprises a WP leader module 200, a WP follower module 210 and a WP retailer module 220. The member module 100 is configured to manage member profiles in the data storage area 45 of the WP server 40.

The WP leader module 200 is configured to manage the WP leader aspects of a WP member profile. For example, the WP leader module 200 operates in conjunction with the deal module 120 to update the WP leader rating value of a WP member profile when a deal closes. In one embodiment, the WP leader rating value can be determined based on objective criteria and metrics from the closed deal and also based on subjective feedback from participants in the closed deal such as WP follower(s) and WP retailer(s). The WP leader module 200 also operates in conjunction with the group module 110 to facilitate membership of the WP member in various groups that may be linked to the WP member's status as a WP leader.

The WP follower module 210 is configured to manage the WP follower aspects of a WP member profile. For example, the WP follower module 210 operates in conjunction with the deal module 120 to update the WP follower rating value of a WP member profile when a deal closes. In one embodiment, the WP follower rating value can be determined based on objective criteria and metrics from the closed deal and also based on subjective feedback from participants in the closed deal such as the WP leader(s) and WP retailer(s). The WP follower module 210 also operates in conjunction with the group module 110 to facilitate membership of the WP member in various groups that may be linked to the WP member's status as a WP follower.

The WP retailer module 220 is configured to manage the WP retailer aspects of a WP member profile. For example, the WP retailer module 220 operates in conjunction with the deal module 120 to update the WP retailer rating value of a WP member profile when a deal closes. In one embodiment, the WP retailer rating value can be determined based on objective criteria and metrics from the closed deal and also based on subjective feedback from participants in the closed deal such as WP leader(s) and WP follower(s). The WP retailer module 220 also operates in conjunction with the group module 110 to facilitate membership of the WP member in various groups that may be linked to the WP member's status as a WP retailer.

FIG. 4 is a block diagram illustrating an example group module 110 in a bulk purchasing server according to an embodiment of the present invention. In the illustrated embodiment, the group module 110 comprises a membership module 250, a hierarchy module 260, an aggregation module 270, and a metagroup module 280. The group module 110 is configured to manage group memberships of the various member profiles and groups in the data storage area 45 of the WP server 40.

The membership module 250 is configured to manage membership of WP member profiles in one or more groups and manage the WP profile for the group itself. Advantageously, a WP member profile can be a member of a plurality of groups simultaneously. Additionally, the membership module 250 is also configured to manage membership of groups in other groups. In one embodiment, the WP profile for a first group includes certain metadata about the first group, for example the common interest(s) shared by the WP members and WP groups that are part of the first group.

The hierarchy module 260 is configured to manage the relationships between groups. In one embodiment, a first group may be a member of a second group and the hierarchical relationship between the first and second groups is managed by the hierarchy module 260. Furthermore, a first group may also be a splinter group from a second group. In such a case, the hierarchical relationship between the first and second groups in that case is also managed by the hierarchy module 260. Advantageously, when a first group splinters from a second group, the first group inherits certain characteristics and metadata from the second group (i.e., the parent group).

The aggregation module 270 is configured to analyze the metadata and characteristics of a first group and then identify common interests or other data that may provide a link between the first group and a second group or a WP member. In this fashion, the aggregation module 270 fosters additional memberships in groups, e.g., membership by individual WP members or membership by WP groups. The aggregation module 270 is also configured to identify potential splinter groups within a WP group. Advantageously, the more homogenous a group is, the more targeted the marketing to that group can be, which provides an incentive to WP retailers to join as a WP member and pay to advertise to the very specifically targeted WP group using the WP server system.

The aggregation module 270 also operates in conjunction with the deal module 120 to assist in the identification of potential like minded consumers and sending communications to such identified like minded consumers. In this capacity, the aggregation module may facilitate the posting of a message marketing a potential deal on a plurality of message boards that reach out to a plurality of discrete WP groups that share one or more common interests or other characteristics or metrics that are part of the potential deal. The aggregation module 270 can operate in conjunction with the hierarchy module 260 to identify the aggregate set of WP groups. Advantageously, the aggregation module 270 can also operate in conjunction with the social interface module 160 to identify external groups that share one or more common interests or other characteristics or metrics that are part of the potential deal and facilitate posting of the message marketing the potential deal on those external group message boards as well.

The metagroup module 280 is configured to operate in conjunction with the social interface module 160 to identify external groups (e.g., Yahoo groups or Google groups) that share one or more common interests or other characteristics or metrics with individual WP members or with WP groups. In one embodiment, the metagroup module collects metadata about these external groups and stores this metadata in the data storage area 45 of the WP server 40. Advantageously, this group metadata is continuously collected and analyzed with similar metadata related to WP groups in order to identify common trends and relationships and hierarchies between the WP groups and the external groups and also to identify common trends and relationships and hierarchies between external groups. In one embodiment, the metagroup module 280 develops and stores a vast data set of information linking a plurality of internal and external groups that facilitates the rapid identification of like minded groups whether the individual groups originate from the WP server or an external source.

FIG. 5 is a block diagram illustrating an example deal module 120 in a bulk purchasing server according to an embodiment of the present invention. In the illustrated embodiment, the deal module 120 comprises a deal offers module 300, a deal requests module 310, a deal details module 320, a deal finder module 330, a deal marketer module 340 and a deal aggregator module 350. The deal module 120 is configured to facilitate creation and management of potential deals and the storage and updating of a data structure associated with each potential deal in the data storage area 45 of the WP server 40.

The deal offers module 300 is configured to receive and accept offers for potentials deals from WP retailers. In one embodiment, the deal offers module 300 operates in conjunction with the member module 100, the group module 110 and the advertising module 170 to identify potential WP leaders and market and promote potential deals that are constructed by a WP retailer to such potential WP leaders. The deal offers module 300 is configured to receive various potential deal related information, metrics, characteristics and metadata and store that information, metrics, characteristics and metadata in a data structure in the data storage area 45 of the WP server 40.

The deal requests module 310 is configured to receive and accept requests for potentials deals from WP leaders. In one embodiment, the deal requests module 310 operates in conjunction with the member module 100, the group module 110 and the social interface module 160 to identify potential WP followers and WP retailers and market and promote potential deals that are constructed by a WP leader to such potential WP followers and WP retailers. The deal requests module 310 is configured to receive various potential deal related information, metrics, characteristics and metadata and store that information, metrics, characteristics and metadata in a data structure in the data storage area 45 of the WP server 40.

The deal details module 320 is configured to manage the various details of a potential deal and store new details in the data storage area 45 of the WP server and store revised details in the data storage area 45 of the WP server. For example, potential deal details stored in a data structure may include the minimum number of WP followers in an acceptable deal or the minimum number of items purchased in an acceptable deal. The deal details may also include a sliding scale of discounted pricing based on the number of units sold or the minimum number of WP followers in the deal. The deal details may also include product or discount delivery information and information regarding whether the potential deal is private or public.

In one embodiment, the deal details module 320 operates in conjunction with the deal marketer module 340 to provisionally update deal information received from a potential WP retailer (e.g., the minimum number of WP members in the wolf pack) and then revise the deal parameters upon acceptance by the WP leader or create a competing potential deal for the specific WP retailer from the provisionally updated deal information. The deal details module 320 also operates in conjunction with the deal aggregator module 350 to create and store data structures representing what-if scenarios when two or more potential deals are hypothetically or actually aggregated. The deal details module 320 also operates in conjunction with the deal finder module 330 to provide relevant deal related information in response to queries.

In one embodiment the deal details module 320 is also configured to manage the list of WP followers and WP retailers that are associated with a potential deals. These attributes of a deal are additional metrics that are managed and stored in the data structure by the deal details module 320. Additionally, the deal details module 320 may also proactively communicate to all of the associated WP members (WP leader, WP followers, WP retailers) updated information about the deal, for example a higher discount rate that now applies after a predetermined threshold number of WP followers have become associated with the potential deal.

The deal finder module 330 is configured to receive search parameters and examiner the various data structures stored in data storage 45 of the WP server 40 and related to potential deals return a result set that identifies potential deals that match all or a portion of the search parameters or are related to the search parameters. In one embodiment, only public potential deals are searched, although in such an embodiment any private deals accessible to the searching WP member are also included in the searched data structures. Advantageously the deal finder module 330 may also search the data storage area 45 for data structures that represented closed deals in order to provide rich historical information to a WP leader or a WP retailer regarding the commercial operation of the wolf pack system.

The deal marketer module 340 is configured to promote a potential deal to potential WP leaders, WP followers and WP retailers. The deal marketer module 340 operates in conjunction with the group module 110 and the social interface module 160 to facilitate marketing to potential like minded consumers that are WP members and potential like minded consumers that can be reached by a communication to an external group message board, for example. The deal marketer module 340 also operates in conjunction with the advertising module 170 to facilitate marketing a potential deal to potential WP leaders that may be interested and willing to champion the potential deal created by a WP retailer.

The deal aggregator module 350 is configured to analyze the various metrics, characteristics and metadata associated with potential deals and compare and contrast such information to identify two or more potential deals that can be aggregated into a single deal for the benefit of the two or more wolf packs and the WP retailer(s). The deal aggregator 350 operates in conjunction with the deal details module 320 to create and store data structures for such hypothetical aggregate deals and to transition a hypothetical aggregate deal into a real potential deal. The deal aggregator module 350 is also configured to allow a WP leader or WP follower or WP retailer to develop what-if scenarios regarding hypothetical aggregated deals and store a data structure in accordance with a hypothetical aggregated deal for later promotion to interested parties.

FIG. 6 is a block diagram illustrating an example rating module 140 in a bulk purchasing server according to an embodiment of the present invention. In the illustrated embodiment, the rating module 140 comprises a leader rating module 360, a follower rating module 370, a retailer rating module 380, and a deal rating module 390. The rating module 140 is configured to determine and manage WP leader, WP follower and WP retailer ratings of the various WP member profiles in the data storage area 45 of the WP server 40.

The leader rating module 360 is configured to manage the calculation and updating of the WP leader rating value for a WP member and store a new or modified WP leader rating value in the data storage area 45 in association with the corresponding WP member profile.

The follower rating module 370 is configured to manage the calculation and updating of the WP follower rating value for a WP member and store a new or modified WP follower rating value in the data storage area 45 in association with the corresponding WP member profile.

The retailer rating module 380 is configured to manage the calculation and updating of the WP retailer rating value for a WP member and store a new or modified WP retailer rating value in the data storage area 45 in association with the corresponding WP member profile.

The deal rating module 390 is configured to analyze demographic data, metrics, and related metadata for a potential deal and create a deal score that is a rating for the potential deal. The rating can then be stored in the data storage area 45 and used to market the potential deal to potential WP followers and WP retailers.

When calculating the rating for a potential deal, the deal rating module 390 may analyze demographic data and other information from completed deals that are stored in the data storage area 45 of the WP server 40 and compare the such demographic data and other information from the past deals to the demographic data and similar information of the potential deal to generate the deal score and rating. In one embodiment, the current and prior WP leaders, current and prior WP followers and current and prior potential WP retailer(s) may be factored into the deal score and rating.

Additionally, the deal rating module 390 may provide relative rating for deals to the social interface module for use in determining a relative priority for each of the pending potential deals so that a corresponding <priority> value may be set in a sitemap that is provided to a conventional search engine.

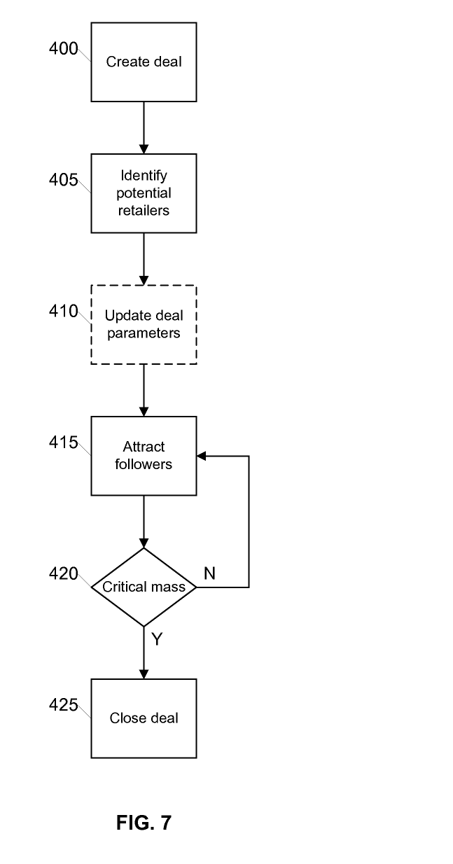

FIG. 7 is a flow diagram illustrating an example process for bulk purchasing by ad hoc consumer groups according to an embodiment of the present invention. The illustrated process can be implemented by the bulk purchasing system previously described with respect to FIGS. 1-6. Initially, in step 400 a potential deal is created. This can be done by a WP leader using the WP server. Creating a deal includes creating and storing a data structure in a computer readable storage medium where the data structure includes the various desired characteristics of the deal. Next, in step 405 potential retail partners are identified. The potential retail partners can be existing WP retailer members or a retailer that is not yet a WP retailer member.

In step 410, the system can optionally update the desired deal parameters, for example based on feedback from one or more potential retailers about the deal parameters. In one embodiment, instead of updating the deal parameters, a competing parallel deal is stored as a data structure in the data storage area such that the wolf pack seeking a desired deal now has at least two potential deals to evaluate for selection.

Next, in step 415, the potential deal is marketed to identify potential WP followers. The marketing of the potential deal may take place through internal WP groups and also by leveraging external social networking applications and relationships that allow a WP leader or WP follower or even the WP retailer to market and promote the deal to additional like minded consumers. In step 420, it is determined if the required metrics to close the deal have been achieved. For example, if the critical mass of WP followers has been achieved or if the desired threshold of WP followers has been achieved to obtain the desired discount. Advantageously, if the desired metrics and critical mass have not yet been achieved, then the process loops back into marketing mode to promote the deal and attract additional WP followers. Once the desired metrics or critical mass have been achieved, as determined in step 420, the system closes the deal in step 425. Closing the deal may include managing the exchange of funds for goods between the WP leader and WP followers and the WP retailer. Alternatively, closing the deal may include delivery of a coupon or a gift card to the WP leader and WP followers. In such a scenario, the exchange of funds for goods (or services) may take place offline from the WP server.

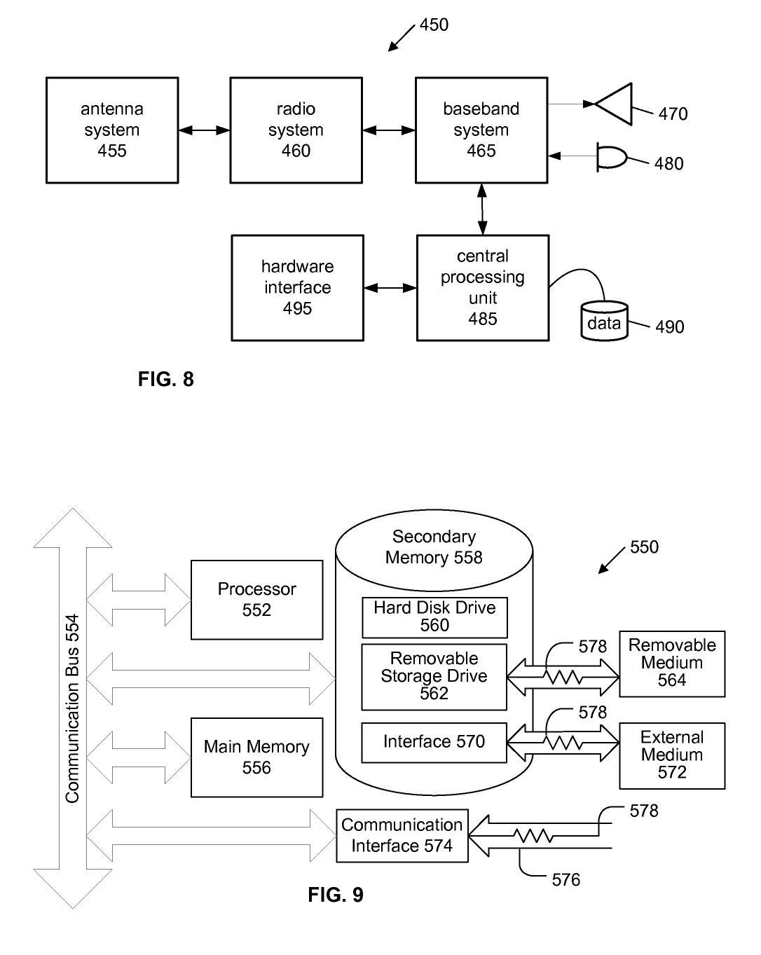

FIG. 8 is a block diagram illustrating an example wireless communication device 450 that may be used in connection with various embodiments described herein. For example, the wireless communication device 450 may be used in conjunction with the previously described WP leader device or WP member device. While the wireless communication device 450 may also be used on conjunction with the previously described WP server device or WP retailer device, those devices most likely require more processing and data storage resources that would typically be found on wireless communication device 450. However, other wireless communication devices and/or architectures with sufficient physical resources may also be used, as will be clear to those skilled in the art.

In the illustrated embodiment, wireless communication device 450 comprises an antenna system 455, a radio system 460, a baseband system 465, a speaker 470, a microphone 480, a central processing unit (“CPU”) 485, a data storage area 490, and a hardware interface 495. In the wireless communication device 450, radio frequency (“RF”) signals are transmitted and received over the air by the antenna system 455 under the management of the radio system 460.

In one embodiment, the antenna system 455 may comprise one or more antennae and one or more multiplexors (not shown) that perform a switching function to provide the antenna system 455 with transmit and receive signal paths. In the receive path, received RF signals can be coupled from a multiplexor to a low noise amplifier (not shown) that amplifies the received RF signal and sends the amplified signal to the radio system 460.

In alternative embodiments, the radio system 460 may comprise one or more radios that are configured to communication over various frequencies. In one embodiment, the radio system 460 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 460 to the baseband system 465.

If the received signal contains audio information, then baseband system 465 decodes the signal and converts it to an analog signal. Then the signal is amplified and sent to the speaker 470. The baseband system 465 also receives analog audio signals from the microphone 480. These analog audio signals are converted to digital signals and encoded by the baseband system 465. The baseband system 465 also codes the digital signals for transmission and generates a baseband transmit audio signal that is routed to the modulator portion of the radio system 460. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 455 where the signal is switched to the antenna port for transmission.

The baseband system 465 is also communicatively coupled with the central processing unit 485. The central processing unit 485 has access to a data storage area 490. The central processing unit 485 is preferably configured to execute instructions (i.e., computer programs or software) that can be stored in the data storage area 490. Computer programs can also be received from the baseband processor 465 and stored in the data storage area 490 or executed upon receipt. Such computer programs, when executed, enable the wireless communication device 450 to perform the various functions of the present invention as previously described. For example, data storage area 490 may include various software modules (not shown) that were previously described with respect to FIG. 2.

In this description, the term “computer readable medium” is used to refer to any storage media used to provide executable instructions (e.g., software and computer programs) to the wireless communication device 450 for execution by the central processing unit 485. These computer readable storage media are means for providing executable code, programming instructions, and software to the wireless communication device 450. The executable code, programming instructions, and software, when executed by the central processing unit 485, preferably cause the central processing unit 485 to perform the inventive features and functions previously described herein.

The central processing unit 485 is also preferably configured to receive notifications from the hardware interface 495 when new devices are detected by the hardware interface. Hardware interface 495 can be a combination electromechanical detector with controlling software that communicates with the CPU 485 and interacts with new devices. The hardware interface 495 may be a firewire port, a USB port, a Bluetooth or infrared wireless unit, or any of a variety of wired or wireless access mechanisms. Examples of hardware that may be linked with the device 450 include data storage devices, computing devices, headphones, microphones, and the like.

FIG. 9 is a block diagram illustrating an example computer system 550 that may be used in connection with various embodiments described herein. For example, the computer system 550 may be used in conjunction with the previously described WP leader device, WP member device, WP server device or WP retailer device. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described. For example, data storage areas 556 and 558 may include various software modules (not shown) that were previously described with respect to FIG. 2.

In this description, the term “computer readable storage medium” is used to refer to any storage media used to provide computer executable code (e.g., software and computer programs) to the computer system 550. Examples of these storage media include main memory 556, secondary memory 558 (including hard disk drive 560, removable storage medium 564, and external storage medium 572), and any peripheral device communicatively coupled with communication interface 574 (including a network information server or other network device). These computer readable storage media are means for providing executable code, programming instructions, and software to the computer system 550.

In an embodiment that is implemented using software, the software may be stored on a computer readable storage medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A computer implemented method for facilitating transactions, where one or more processors are programmed to perform steps comprising:
receiving at a server, information regarding at least one of a product and a service for which a group discount is to be solicited;
communicating at least some of said information regarding the at least one of a product and service to a plurality of individuals;
requesting information indicating interest in said at least one of a product and service from said plurality of individuals;
receiving information from one or more of said plurality of individuals; and
presenting interested individuals a pricing discount for said at least one product and service, said pricing discount being a function of a sales volume of said at least one of a product and a service.

2. The method of claim 1, further comprising prior to presenting interested individuals a pricing discount, receiving volume based discount information corresponding to a deal negotiated based on the information received from said one or more of said plurality of individuals.

3. The method of claim 1, where receiving at a server information regarding at least one of a product and a service for which a group discount is to be solicited includes receiving information about a product or service from an individual seeking to initiate a volume based discount offer.

4. The method of claim 1, further comprising identifying one or more individuals to communicate information regarding the at least one of a product and service based on membership within a group.

5. The method of claim 4, further comprising wherein identifying one or more individuals to communicate information regarding the at least one of a product and service is further based on geographic information which is known about members within said group.

6. The method of claim 1, further comprising:
collecting payment from individuals interested in said volume pricing discount prior to said individuals being provided said at least one of a product and a service; and
determining the amount of discount to be provided based on the collected payments.

7. The method of claim 6, further comprising providing a portion of the collected payments to a seller providing said at least one of a product and a service.

8. The method of claim 7, further comprising retaining a portion of the collect payments as a service fee.

9. The method of claim 7, further comprising providing purchase redemption information to individuals participating in said volume pricing discount.

10. The method of claim 7, further comprising scheduling timing windows for different individuals during which said at least one product can be picked up at a store, a plurality of different timing windows being scheduled for different sets of individuals participating in said volume pricing discount.

11. The method of claim 1, further comprising scheduling timing windows for different individuals during which said at least one product can be picked up at a store, a plurality of different timing windows being scheduled for different sets of individuals participating in said volume pricing discount.

12. The method of claim 1, further comprising scheduling timing windows for different individuals during which said at least one service can be picked up at a store, a plurality of different timing windows being scheduled for different sets of individuals participating in said volume pricing discount.

13. A system comprising at least one processor communicatively coupled with at least one computer readable storage medium, wherein the processor is programmed to facilitate transactions by:
receiving at a server, information regarding at least one of a product and a service for which a group discount is to be solicited;
communicating at least some of said information regarding the at least one of a product and service to a plurality of individuals;
requesting information indicating interest in said at least one of a product and service from said plurality of individuals;
receiving information from one or more of said plurality of individuals; and
presenting interested individuals a pricing discount for said at least one product and service, said pricing discount being a function of a sales volume of said at least one of a product and a service.

14. A computer readable storage medium having stored thereon one or more sequences of instructions for causing one or more processors to perform the steps for facilitating transactions, the steps comprising:
receiving at a server, information regarding at least one of a product and a service for which a group discount is to be solicited;
communicating at least some of said information regarding the at least one of a product and service to a plurality of individuals;
requesting information indicating interest in said at least one of a product and service from said plurality of individuals;
receiving information from one or more of said plurality of individuals; and
presenting interested individuals a pricing discount for said at least one product and service, said pricing discount being a function of a sales volume of said at least one of a product and a service.

15. A technical system for facilitating transactions, the system comprising:
a computer readable storage medium for storing computer executable programmed modules;
a processor communicatively coupled with the computer readable storage medium for executing programmed modules stored therein;
a deal module stored in the computer readable storage medium and configured to be executed by the processor to receive information regarding at least one of a product and a service for which a group discount is to be solicited;
a social interface module stored in the computer readable storage medium and configured to be executed by the processor to communicate at least some of said information regarding the at least one of a product and service to a plurality of individuals and a plurality of providers of said at least one product or service;
wherein the deal module is further configured to identify a plurality of interested individuals and associate said interested individuals with said group discount to be solicited and present said interested individuals with a pricing discount for said at least one product or service, said pricing discount being a function of a sales volume of said at least one of a product or a service.
